(19) United States
(12) Patent Application Publication
(10) Pub. No.: US 2014/0146668 A1
(43) Pub. Date: May 29, 2014

(54) APPARATUS OF CONTROLLING DATA TRAFFIC IN PACKET BASED MOBILE COMMUNICATION SYSTEM AND METHOD THEREOF

(71) Applicant: ELECTRONICS AND TELECOMMUNICATIONS RESEARCH INSTITUTE, DAEJEON (KR)

(72) Inventors: Jong Geun PARK, Daejeon (KR); No Ik PARK, Daejeon (KR); Young Boo KIM, Sejong (KR); Soon Seok LEE, Daejeon (KR)

(73) Assignee: ELECTRONICS AND TELECOMMUNICATIONS RESEARCH INSTITUTE, DAEJEON (KR)

(21) Appl. No.: 14/087,243

(22) Filed: Nov. 22, 2013

(30) Foreign Application Priority Data
Nov. 23, 2012 (KR) 10-2012-0133755

(51) Int. Cl. H04W 28/08; H04W 28/02

(52) U.S. Cl. CPC H04W 28/085; H04W 28/0268
USPC 370/230

(57) ABSTRACT

An apparatus of controlling a data traffic in a packet based mobile communication system and a method thereof according to the present invention are disclosed. The apparatus of controlling a data traffic in a packet based mobile communication system according to another aspect of the present invention includes an extracting unit configured to, if a message which requests to create a dedicated bearer, extract at least one characteristic parameter included in the received message, a determining unit configured to determine whether the dedicated bearer is set through the load distribution gateway based on the at least one extracted characteristic parameter, an already set regulation or condition; and a creating unit configured to create a message which requests to set the dedicated bearer as a result of the determination.

### CROSS-REFERENCE TO RELATED APPLICATIONS

This application claims priority to and the benefit of Korean Patent Application No. 10-2012-0133755 filed in the Korean Intellectual Property Office on Nov. 23, 2012, the entire contents of which are incorporated herein by reference.

### TECHNICAL FIELD

The present invention relates to a packet based mobile communication system, and specifically, to an apparatus of controlling a data traffic in a packet based mobile communication system which includes a load distribution gateway provided in a position separate from a path through which a data traffic is delivered and selectively bypasses a packet core network in accordance with a property of the data traffic in the load distribution gateway and a method thereof.

### BACKGROUND ART

Generally, a mobile terminal can use a packet exchange data service through a mobile communication system. 3GPP (third generation partnership project) which is one of international organizations for standardization for a mobile communication technology leads a technology standardization of mobile communication service and system such as GSM, GPRS, UMTS, and E-UMTS.

Specifically, E-UMTS which realizes All-IP in the mobile communication system has a system network structure as illustrated in FIG. 1. A mobile terminal 101 is wirelessly interconnected to eNodeB 102 which is a LTE base station of an E-UTRAN 102 and a traffic session with the mobile terminal 101 needs to be connected through a packet core network 107 in order to use a service of a service network 109 of the mobile communication service provider such as the Internet 108, MMS, or a video streaming. Generally, the packet core network 107 includes an MME (mobility management entity) 106 which manages a session and a mobility of a terminal, a SGW (serving gateway) 104, and a PGW (packet data network gateway) 105.

In such an E-UMTS mobile communication system, a network capacity plan for every region is established in order to improve a service quality and the E-UTRAN 103 and an evolved packet core 107 including a base station 102 are disposed so as to sufficiently provide a satisfactory service. However, shortage of wireless resources of UMTS which is a 3G service and limitation of a capacity of a wireless backhaul due to appearance of a smart phone and a sudden increase of mobile data cause problems to smoothly provide a service. Therefore, in order to solve the current problems, the mobile communication service provider provides a bypass path through a WiFi network and early change to a 4G LTE service together with various plans for installation of additional networks.

However, as mobile terminals are diversified, mobile data increases geometrically. Further, as an importance of masssive data such as a video is increased in a mobile service, in addition to a method of solving a problem of shortage of wireless resource, such as WiFi or FemtoCell, an introduction of a new network load distribution technology is strongly demanded in order to solve a problem of insufficient capacity of a packet core network 107.

According to a 3GPP standard technology of the related art, as a method which bypasses only a traffic which accesses the Internet 108, among traffics which enters through a base station 102, directly to the Internet without passing through the packet core network 107, SIPTO (selected IP traffic offload TS 23.829) has been discussed, but specific method and system are still being studied.

Even though not standardized, as another related art, United State Unexamined Patent Publication No. 2011-0116499 A1 (entitled “Method and system for selectively bypassing packet core network within a session based on traffic type”) discloses that MDO-GW (mobile data offloading gateway) 204 which bypasses Internet traffic is disposed on a network line between RNC 202 and SGSN 205 to access the Internet 208 through a bypass path rather than a path which passes through the packet core network, in an UMTS mobile communication system as illustrated in FIG. 2.

However, when the packet is bypassed through the method disclosed in the related art, it is required that all packets which flow between an RNC 202 and an SGSN 205 are intercepted by MDO-GW 204 to analyze a header of multiple protocol hierarchies and then it is determined whether a specific packet is a control signaling packet, and further a packet which requests to access the Internet 208 needs to be distinguished in a control signaling packet. Thereafter, information on a GTP tunnel which is set between the RNC 202 and the SGSN 205 is intercepted and information on a GTP tunnel between the RNC 202 and the MDO-GW 204 and information on a GTP tunnel between the MDO-GW 204 and the SGSN 205 are generated and set so as to be distinguished from each other. Therefore, in the case of load distribution according to the above technology, a load for the Internet traffic can be distributed but a load for performing the packet inspection and resetting a GTP tunneling endpoint in the MDO-GW 204 is very high.

Further, prior to introducing the load distribution technology, all traffic loads which pass through the SGSN 205 are applied to the MDO-GW 204 as it is, so that a burden of extending for a capacity of the packet core network 207 is lessened but a burden of extending for the capacity which is applied to the packet core network 207 prior to the load distribution is applied to the MDO-GW 204.

### SUMMARY OF THE INVENTION

The present invention has been made in an effort to provide an apparatus of controlling a data traffic in a packet based mobile communication system which includes a load distribution gateway provided in a position separate from a path through which a data traffic is delivered and selectively bypasses a packet core network in accordance with a property of the data traffic in the load distribution gateway and a method thereof.

However, an object of the present invention is not limited to the above description and other objects which have not been mentioned above will be more apparent to those skilled in the art from a reading of the following description.

An apparatus of controlling a data traffic in a packet based mobile communication system according to an aspect of the present invention, may include a communication unit configured to receive a message which requests to set a dedicated bearer between a user terminal and the communication unit; an extracting unit configured to extract at least one of characteristic parameters included in the received message; a determining unit configured to determine whether to set the dedicated bearer through the load distribution gateway based on the at least one extracted characteristic parameter; and a creating unit configured to create a message which instructs to set the dedicated bearer as a result of the determination.

The characteristic parameter may include QoS (quality of service) characteristic information and packet filter information.

The communication unit may receive a message which requests to set the dedicated bearer from the user terminal.

The communication unit may receive a message which requests to set the dedicated bearer from a P-GW (packet data network gateway) in a packet core network to which the communication unit belongs.

If the at least one extracted characteristic parameter satisfies a pre-set regulation or condition, the determining unit determines that the dedicated bearer is set through the load distribution gateway.

The communication unit may transmit the created message which instructs to set the dedicated bearer to the load distribution gateway and receives a message which requests to create the dedicated bearer as a response.

If the message which requests to create the dedicated bearer is received, the creating unit creates a message which requests to activate the dedicated bearer to transmit the message to the user terminal.

The creating unit may include GTP tunnel endpoint information in the message which requests to activate the dedicated bearer.

A method of controlling a data traffic in a packet based mobile communication system according to another aspect of the present invention, may include receiving a message which requests to set a dedicated bearer between a user terminal and a load distribution gateway, extracting at least one of characteristic parameters included in the received message; determining whether the dedicated bearer is set through the load distribution gateway based on the at least one extracted characteristic parameter, a pre-set regulation or condition; and creating a message which instructs to set the dedicated bearer as a result of the determination.

The characteristic parameter may include QoS (quality of service) characteristic information and packet filter information.

The receiving may receive a message which requests to set the dedicated bearer from the user terminal.

The receiving may receive a message which requests to set the dedicated bearer from a P-GW (packet data network gateway) in a packet core network to which the communication unit belongs.

If the at least one extracted characteristic parameter satisfies a pre-set regulation or condition, the determining determines that the dedicated bearer is set through the load distribution gateway.

The method of controlling a data traffic in a packet based mobile communication system according to another aspect of the present invention, may further include transmitting the created message which instructs to set the dedicated bearer to the load distribution gateway, and receiving a message which requests to create the dedicated bearer as a response.

The method of controlling a data traffic in a packet based mobile communication system according to another aspect of the present invention may further include, if the message which requests to create the dedicated bearer is received, creating a message which requests to activate the dedicated bearer to transmit the message to the user terminal.

The message which requests to activate the dedicated bearer may include GTP tunnel endpoint information.

The present invention includes a load distribution gateway in a location separate from a path through which the data traffic is delivered and allows the data traffic to selectively bypass the packet core network in the load distribution gateway in accordance with the property of the data traffic to lessen the load which is applied to the packet core network.

Further, the present invention includes a load distribution gateway in a location separate from a path through which the data traffic is delivered and allows the data traffic to selectively bypass the packet core network in the load distribution gateway in accordance with the property of the data traffic to provide the same function only by a low capacity load distribution gateway.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a view illustrating a structure of a general E-UMTS system according to a related art.

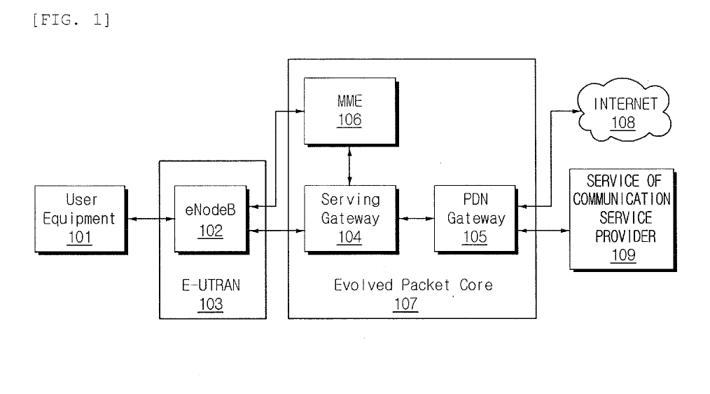

FIG. 2 is a view illustrating a concept of an In-line load distribution technology in an UMTS system.

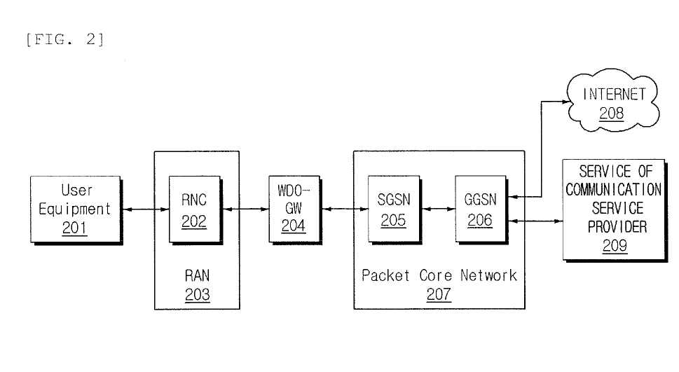

FIG. 3 is a view illustrating a configuration of an E-UMTS system according to an exemplary embodiment of the present invention.

FIG. 4 is a view illustrating a detailed configuration of an MME according to an exemplary embodiment of the present invention.

FIG. 5 is a first view illustrating a method of setting a dedicated bearer according to an exemplary embodiment of the present invention.

FIG. 6 is a second view illustrating a method of setting a dedicated bearer according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

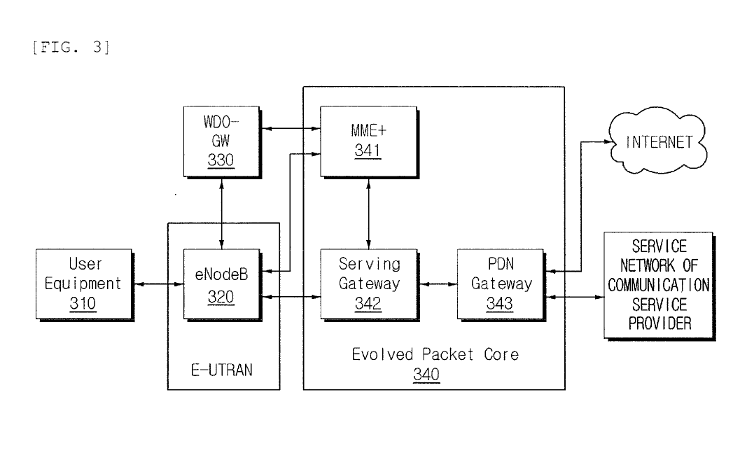

Hereinafter, an apparatus and a method of controlling a data traffic in a packet based mobile communication system according to an exemplary embodiment of the present invention will be described with reference to FIGS. 3 to 6. Parts which are required to understand an operation and an effect of the present invention will be mainly described in detail.

In the description of components of an exemplary embodiment, a component having the same name may be denoted by a different reference numeral in some drawings but may be denoted by the same reference numeral even in different drawings. However, even in this case, it does not mean that the component has different functions depending on the exemplary embodiment or the components have the same function in the different exemplary embodiments but the function of each of the components may be determined based on the description of the components in the corresponding exemplary embodiment.

Specifically, the exemplary embodiment suggests a new method that provides a load distribution gateway in a location separate from a path through which the data traffic is delivered in a packet based mobile communication system, specifically, in an E-UMTS (evolved universal terrestrial radio access network) mobile communication system environment and allows the data traffic to selectively bypass a packet core network in the provided load distribution gateway.

In this case, the E-UMTS is also referred to as an EPS (evolved packet system) and generally is used as a name of an LTE (long term evolution) which indicates a wireless access network.

FIG. 3 is a view illustrating a configuration of an E-UMTS system according to an exemplary embodiment of the present invention.

As illustrated in FIG. 3, the E-UMTS system according to an exemplary embodiment includes a user terminal (UE) 310, a base station 320, a load distribution gateway 330, and a packet core network 340.

The user terminal 310 transmits and receives a data traffic through a packet based mobile communication system. Here, the user terminal may be a terminal which is carried and used by the user, and for example, is a concept including a mobile phone, a smart phone, a PDA, a tablet PC, and a notebook computer.

The base station 320 is an enodeB (evolved nodeB) which is a radio base station and wirelessly interconnected with the user terminal 310. The load distribution gateway 330 may be an MDO-GW (mobile data offloading gateway). The load distribution gateway 330 may set a dedicated bearer so that the user terminal 310 directly uses a service network of a communication service provider which provides a service such as an Internet, MMS, or video streaming without passing through the packet core network 340.

In this case, in order to use the packet data service, the user terminal may set a default bearer as a basic data path for allocating a resource between the packet core network and the user terminal to use the packet data service.

If additional new QoS (quality of service) is required to be applied, the user terminal may additionally create a dedicated bearer between the load distribution gateway 330 and the user terminal 310 in addition to the default bearer to be provided the service using the created dedicated bearer.

The packet core network 340 includes an MME (mobility management entity) 341, an S-GW (serving gateway) 342, and a P-GW (PDN gateway) 343.

The MME 341 may be requested to create a dedicated bearer from the user terminal 310 or the P-GW 343. If the dedicated bearer is created, the MME 341 sets the transmission path of the data traffic, that is, the dedicated bearer through the load distribution gateway 330 in accordance with the pre-set regulation or condition to determine whether to bypass the data traffic.

In this case, the pre-set regulation or condition may indicate a threshold value such as GoS property information or packet filter information.

If it is determined to allow the data traffic to bypass the packet core network, the MME 341 may request the load distribution gateway to set the dedicated bearer to transmit the data traffic.

The S-GW 342 may deliver the data traffic which is received from the base station to the P-GW 342.

If the data traffic is delivered from the SGW 342, the P-GW 343 may transmit the transmitted data traffic to the service network of the Internet or communication service provider through the default bearer.

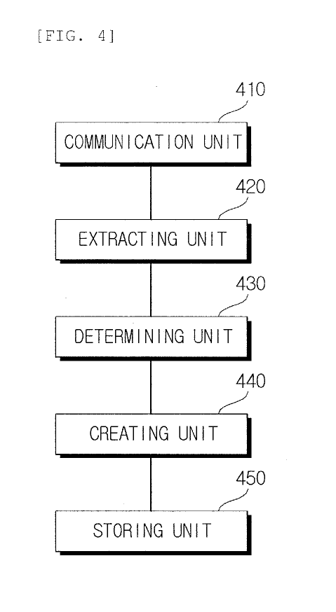

FIG. 4 is a view illustrating a detailed configuration of an MME according to an exemplary embodiment of the present invention.

As illustrated in FIG. 4, the MME 341 according to an exemplary embodiment includes a communication unit 410, an extracting unit 420, a determining unit 430, a creating unit 440, and a storing unit 450.

The communication unit 410 receives a message which requests to set a dedicated bearer from the user terminal or the P-GW in the packet core network. For example, the communication unit 410 may receive a bearer resource allocation request message from the user terminal through the base station or a create bearer request message from the P-GW through the S-GW.

The extracting unit 420 extracts a characteristic parameter such as QoS characteristic information or packet filter information from the received message.

The determining unit 430 compares the characteristic parameter such as the extracted QoS characteristic information or the packet filter information with the pre-set regulation or condition to determine whether to set the dedicated bearer through the load distribution gateway in accordance with the comparison result.

For example, if the extracted characteristic parameter satisfies the pre-set regulation or condition, the determining unit 430 determines to set the dedicated bearer through the load distribution gateway.

In this case, the pre-set regulation or condition may be a QoS characteristic information value or a packet filter information value and such information is stored in the storing unit 450 to be changed if necessary.

If it is determined to set the dedicated bearer through the load distribution gateway, the creating unit 440 may create a bearer resource command message to instruct to set the dedicated bearer.

The bearer resource command message created as described above is transmitted to the load distribution gateway and the load distribution gateway sets a dedicated bearer between the user terminal and the load distribution gateway.

In this case, the message which is received and transmitted on the mobile communication system, a format, and information items follows NAS (TS 24.301), SlAP (TS 36.413), and GTP-C (TS 29.274) standards of 3GPP.

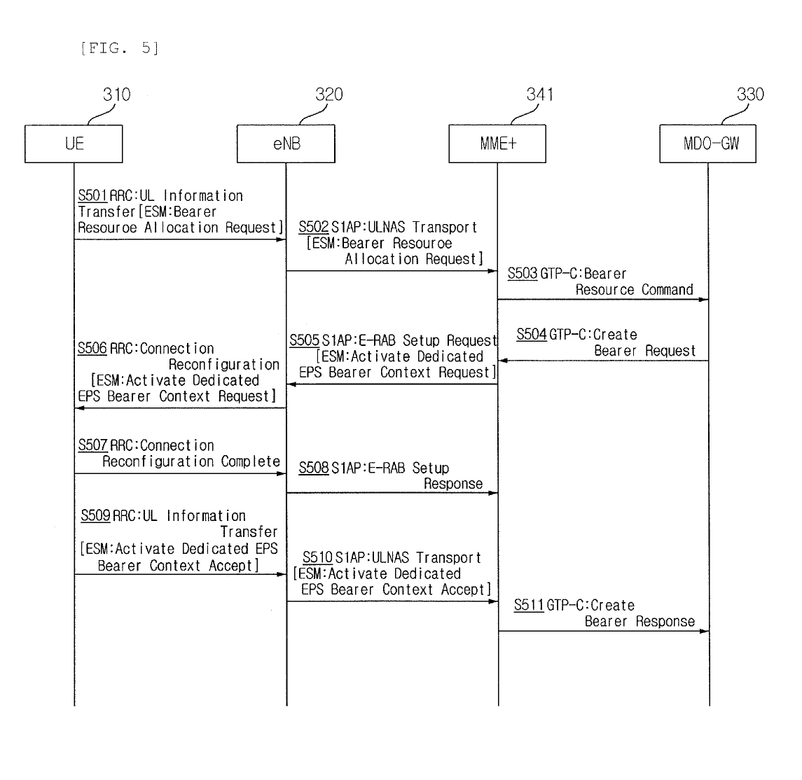

FIG. 5 is a first view illustrating a method of setting a dedicated bearer according to an exemplary embodiment of the present invention.

As illustrated in FIG. 5, in step S501, the user terminal transmits the bearer resource allocation request message to request to create the dedicated bearer to the base station and in step S502, the base station delivers the bearer resource allocation request message to the MME in the packet core network.

Next, the MME determines whether to set the dedicated bearer through the load distribution gateway based on the characteristic parameter included in the bearer resource allocation request message and the pre-set regulation or condition.

Next, in step S503, if it is determined to set the dedicated bearer through the load distribution gateway, the MME may transmit the bearer resource command message to instruct to set the dedicated bearer to the load distribution gateway.

Next, in step S504, if the bearer resource command message is received, the load distribution gateway may transmit a create bearer request message to request to create the dedicated bearer to the MME.

In this case, the create bearer request message may include GTP tunnel endpoint information.

Next, if the create bearer request message is received, in step S505, the MME transmits a active dedicated EPS bearer context request message to request to activate the dedicated bearer to the base station and in step S506, the base station delivers the active dedicated EPS bearer context request message to the user terminal.

If the active dedicated EPS bearer context request message is received, in step S507, the user terminal transmits a connection reconfiguration complete message to complete the reconstruction of the GTP tunnel between the user terminal and the load distribution gateway based on the GTP tunnel endpoint information included in the received active dedicated EPS bearer context request message to the base station and in step S508, the base station transmits an E-RAS setup resource message to the MME.

Next, in step S509, the user terminal delivers the active dedicated EPS bearer context accept message which accepts the activation of he dedicated bearer to the base station and in step S510, the base station transmits the delivered active dedicated EPS bearer context accept message to the MME again.

Next, if the active dedicated EPS bearer context accept message is received, in step S511, the MME transmit a create bearer request message to the load distribution gateway to response for the creation of the dedicated bearer as a reply for the create bearer request message.

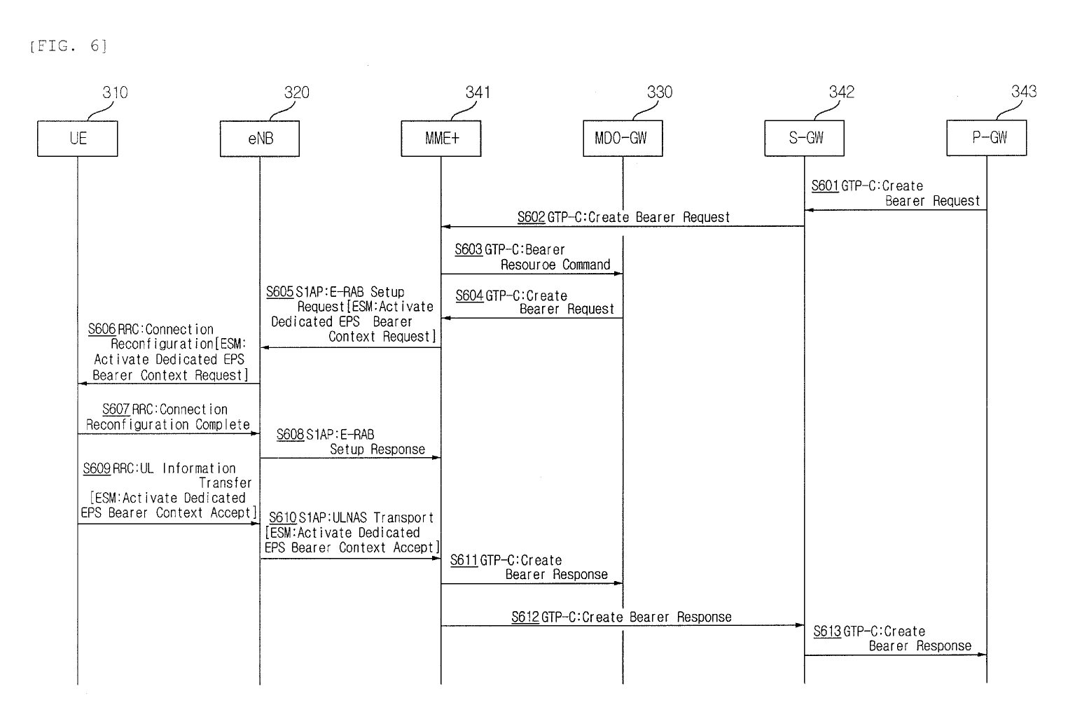

FIG. 6 is a second view illustrating a method of setting a dedicated bearer according to an exemplary embodiment of the present invention.

As illustrated in FIG. 6, in step S601, the P-GW in the packet core network delivers the create bearer request message to request to create the dedicated bearer and in step S602, the S-GW transmits the delivered create bearer request message to the MME.

Next, in step S603, the MME transmits a bearer resource command message which instructs to set the dedicated bearer to the load distribution gateway.

Next, in step S604, if the bearer resource command message is received, the load distribution gateway may transmit a create bearer request message to request to create the dedicated bearer to the MME.

In this case, the create bearer request message may include GTP tunnel endpoint information.

Next, if the create bearer request message is received, in step S605, the MME transmits a active dedicated EPS bearer context request message to request to activate the dedicated bearer to the base station and in step S606, the base station delivers the active dedicated EPS bearer context request message to the user terminal.

If the active dedicated EPS bearer context request message is received, in step S607, the user terminal transmits a connection reconfiguration complete message to complete the reconstruction of the GTP tunnel between the user terminal and the load distribution gateway based on the GTP tunnel endpoint information included in the received active dedicated EPS bearer context request message to the base station and in step S608, the base station transmits an E-RAB setup resource message to the MME.

Next, in step S609, the user terminal delivers the active dedicated EPS bearer context accept message which accepts the activation of the dedicated bearer to the base station and in step S610, the base station transmits the delivered active dedicated EPS bearer context accept message to the MME again.

Next, if the active dedicated EPS bearer context accept message is received, in step S611, the MME transmits a create bearer request message to the load distribution gateway to response the creation of the dedicated bearer as a reply for the create bearer request message.

Next, in step S612, the MME delivers the create bearer response message to reply the creation of the dedicated bearer as a response for the create bearer request message and in step S613, the S-GW transmits the delivered create bearer response message to the P-GW again.

Even though all components of the exemplary embodiment may be combined as one component or operates to be combined, the present invention is not limited to the exemplary embodiment. In other words, all components may be selectively combined to be operated within a scope of the present invention. Further, all components may be implemented as one independent hardware but a part or all of the components are selectively combined to be implemented as a computer program which includes a program module which performs a part or all functions combined in one or plural hardwares. Further, such a computer program may be stored in a computer readable storage media such as a USB memory, a CD disk, or a flash memory to be read and executed by a computer to implement the exemplary embodiment of the present invention. The storage media of the computer program may include a magnetic recording medium, an optical recording medium, or a carrier wave medium.

The exemplary embodiments of the present invention which have been described above are examples and it is obvious to those skilled in the art that various changes or modifications may be made without departing from the spirit and scope of the present invention. Accordingly, the various exemplary embodiments disclosed herein are not intended to limit the technical spirit but describe with the true scope and spirit being indicated by the following claims. The scope of the present invention may be interpreted by the appended claims and the technical spirit in the equivalent range is intended to be embraced by the invention.

What is claimed is:

1. An apparatus of controlling a data traffic in a packet based mobile communication system, comprising:
a communication unit configured to receive a message which requests to set a dedicated bearer between a user terminal and the communication unit;
an extracting unit configured to extract at least one of characteristic parameters included in the received message;
a determining unit configured to determine whether the dedicated bearer is set through the load distribution gateway based on the at least one extracted characteristic parameter; and
a creating unit configured to create a message which instructs to set the dedicated bearer as a result of the determination.

2. The apparatus of claim 1, wherein the characteristic parameter includes QoS (quality of service) characteristic information and packet filter information.

3. The apparatus of claim 1, wherein the communication unit receives a message which requests to set the dedicated bearer from the user terminal.

4. The apparatus of claim 1, wherein the communication unit receives a message which requests to set the dedicated bearer from a P-GW (packet data network gateway) in a packet core network to which the communication unit belongs.

5. The apparatus of claim 1, wherein if the at least one extracted characteristic parameter satisfies a pre-set regulation or condition, the determining unit determines that the dedicated bearer is set through the load distribution gateway.

6. The apparatus of claim 1, wherein the communication unit transmits the created message which instructs to set the dedicated bearer to the load distribution gateway and receives a message which requests to create the dedicated bearer as a response.

7. The apparatus of claim 6, wherein if the message which requests to create the dedicated bearer is received, the creating unit creates a message which requests to activate the dedicated bearer to transmit the message to the user terminal.

8. The apparatus of claim 7, wherein the creating unit includes GTP tunnel endpoint information in the message which requests to activate the dedicated bearer.

9. A method of creating a data traffic in a packet based mobile communication system, comprising:
receiving a message which requests to set a dedicated bearer between a user terminal and a distribution gateway;
extracting at least one of characteristic parameters included in the received message;
determining whether the dedicated bearer is set through the load distribution gateway based on the at least one extracted characteristic parameter, a pre-set regulation or condition; and
creating a message which instructs to set the dedicated bearer as a result of the determination.

10. The method of claim 9, wherein the characteristic parameter includes QoS (quality of service) characteristic information and packet filter information.

11. The method of claim 9, wherein the receiving includes receiving a message which requests to set the dedicated bearer from the user terminal.

12. The method of claim 9, wherein the receiving includes receiving a message which requests to set the dedicated bearer from a P-GW (packet data network gateway) in a packet core network to which the communication unit belongs.

13. The method of claim 9, wherein the determining includes determining that the dedicated bearer is set through the load distribution gateway, if the at least one extracted characteristic parameter satisfies a pre-set regulation or condition.

14. The method of claim 9, further comprising:
transmitting the created message which instructs to set the dedicated bearer to the load distribution gateway; and
receiving a message which requests to create the dedicated bearer as a response.

15. The method of claim 14, further comprising:
creating a message which requests to activate the dedicated bearer to transmit the message to the user terminal, if the message which requests to create the dedicated bearer is received.

16. The method of claim 15, wherein the message which requests to activate the dedicated bearer may include GTP tunnel endpoint information.
